(19) United States
(12) Patent Application Publication
(10) Pub. No.: US 2007/0109600 A1
(43) Pub. Date: May 17, 2007

(54) Printer optimization method and system

(75) Inventors: Ning Ren, Lexington, KY (US); Martin Geoffrey Rivers, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/274,028

(22) Filed: Nov. 15, 2005

(51) Int. Cl. G06K 15/00

(52) U.S. Cl. 358/1.18

(57) ABSTRACT

A method includes if an initial page of a multi-page print job includes one or more image objects, storing the one or more image objects of the initial page. If a first subsequent page of the multi-page print job includes one or more image objects, comparing the one or more image objects of the initial page to the one or more image objects of the first subsequent page to determine one or more common image objects. A template page is rendered that includes the one or more common image objects.

### TECHNICAL FIELD

This disclosure relates to printing devices and, more particularly, to methods and systems for improving the efficiency of printing devices, such as the rendering of common background objects.

### BACKGROUND

Printing devices receive print jobs from various sources, such as computers directly attached to the printing device via a printer cable and/or computers indirectly attached to the printing device via a computer network.

Print jobs may be single-page or multi-page print jobs, and multi-page print jobs may include data that is common across multiple pages. For example, slide show presentations (such as those produced using Microsoft PowerPoint™) often use common backgrounds (such as a large graphic or a tiled graphic). Further, these presentations may also include various common images, such as corporate logos and/or photographs. Unfortunately, due to the need to render these redundant images multiple times, printer efficiency may be reduced.

### SUMMARY OF THE DISCLOSURE

In one exemplary implementation, a method includes, if an initial page of a multi-page print job includes one or more image objects, storing the one or more image objects of the initial page. If a first subsequent page of the multi-page print job includes one or more image objects, comparing the one or more image objects of the initial page to the one or more image objects of the first subsequent page to determine one or more common image objects. A template page is rendered that includes the one or more common image objects. If a second subsequent page of the multi-page print job includes one or more image objects that correspond to the one or more common image objects, the second subsequent page is rendered using the template page.

One or more of the following features may be included. The initial page of the multi-page print job may be rendered. The first subsequent page of the multi-page print job may be rendered. Comparing the one or more image objects of the initial page to the one or more image objects of the first subsequent page may include comparing the image characteristics of the one or more image objects of the initial page to the image characteristics of the one or more image objects of the first subsequent page. The image characteristics may include: image geometry; image scaling; and/or image content.

If the first subsequent page of the multi-page print job does not include one or more image objects, the one or more image objects of the initial page may be discarded. At least one image object included within the one or more image objects of the initial page that is not included within the one or more common image objects may be discarded.

If the second subsequent page of the multi-page print job does not include one or more image objects that correspond to the one or more common image objects, the one or more common image objects may be discarded.

The template page may be stored. If a second subsequent page of the multi-page print job does not include one or more image objects that correspond to the one or more common image objects, the template page may be discarded.

The above-described method may be implemented via an integrated circuit and/or as a sequence of instructions executed by a processor.

The details of one or more exemplary implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a printing device;

FIG. 2 is a diagrammatic view of a multi-page print job received by the printing device of FIG. 1;

FIG. 3 is a flow chart of a process executed by the printing device of FIG. 1; and

FIG. 4 is a diagrammatic view of a template page rendered by the printing device of FIG. 1

### DETAILED DESCRIPTION OF THE PREFERRED EMBODIMENTS

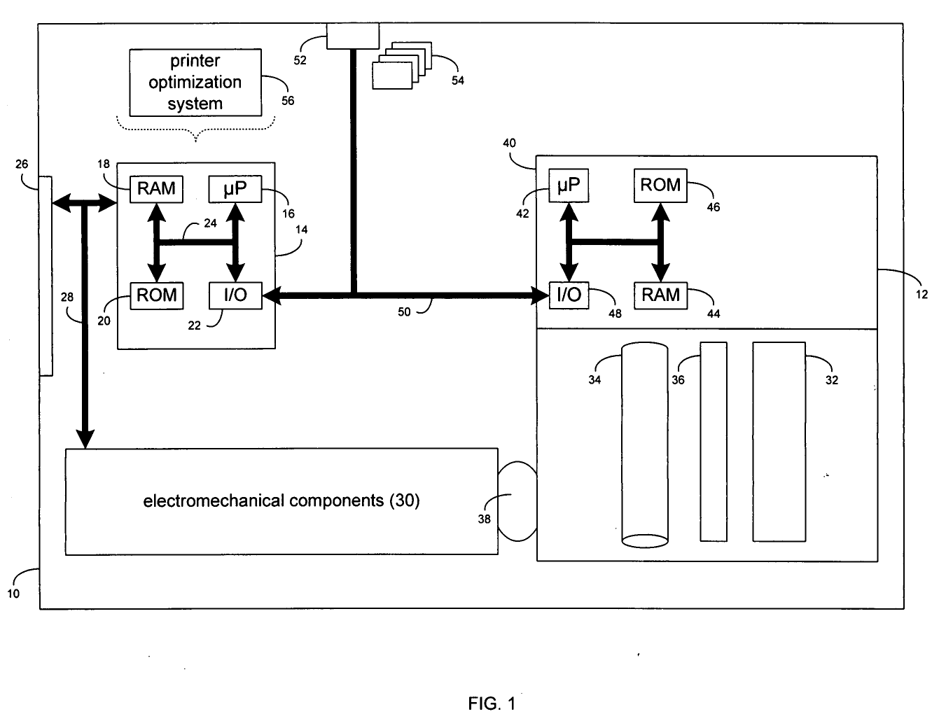

Referring to FIG. 1, there is shown an exemplary printing device 10 and a printer cartridge 12 for use within printing device 10. Printing device 10 may be coupled to a computing device (not shown) via e.g. a parallel printer cable (not shown), a universal serial bus cable (not shown), and/or a network cable (not shown). While printing device 10 is shown (in this example) to be a laser printer, other configurations are possible. For example, printing device 10 may be an inkjet printer, a photocopier, and/or an all-in-one unit.

Printing device 10 may be a device that accepts text and graphic information from a computing device and transfers the information to various forms of media (e.g., paper, cardstock, transparency sheets, etc.). Further, a printer cartridge 12 may be a component of printing device 10, which typically includes the consumables/wear components (e.g. toner, a drum assembly, and a fuser assembly, for example) of printing device 10. Printer cartridge 12 typically also includes circuitry and electronics (not shown) required to e.g., charge the drum and control the operation of printer cartridge 12.

Printing device 10 may include a system board 14 for controlling the operation of printing device 10. System board 14 may include a microprocessor 16, random access memory (i.e., RAM) 18, read only memory (i.e., ROM) 20, and an input/output (i.e., I/O) controller 22. Microprocessor 16, RAM 18, ROM 20, and I/O controller 22 may be coupled to each other via data bus 24. Examples of data bus 24 may include a PCI (i.e., Peripheral Component Interconnect) bus, an ISA (i.e., Industry Standard Architecture) bus, or a proprietary bus, for example.

Printing device 10 may include display panel 26 for providing information to a user (not shown). Display panel 26 may include e.g. an LCD (i.e. liquid crystal display) panel, one or more LEDs (i.e., light emitting diodes), and one or more switches. Display panel 26 may be coupled to I/O controller 22 of system board 14 via data bus 28. Examples of data bus 28 may include a PCI (i.e., Peripheral Component Interconnect) bus, an ISA (i.e., Industry Standard Architecture) bus, or a proprietary bus, for example. Printing device 10 may also include electromechanical components 30, such as: feed motors (not shown), gear drive assemblies (not shown), paper jam sensors (not shown), and paper feed guides (not shown), for example. Electromechanical components 30 may be coupled to system board 14 via data bus 28 and I/O controller 22.

As discussed above, printer cartridge 12 may include a toner reservoir 32, toner drum assembly 34, and fuser assembly 36, for example. Electromechanical components 30 may be mechanically coupled to printer cartridge 12 via a releasable gear assembly 38 that allows printer cartridge 12 to be removed from printing device 10.

Printer cartridge 12 may include a system board 40 that controls the operation of printer cartridge 12. System board 40 may include microprocessor 42, RAM 44, ROM 46, and I/O controller 48, for example. System board 40 may be releasably coupled to system board 14 via data bus 50, thus allowing for the removal of printer cartridge 12 from printing device 10. Examples of data bus 50 may include a PCI (i.e., Peripheral Component Interconnect) bus, an ISA (i.e., Industry Standard Architecture) bus, an I2C (i.e., Inter-IC) bus, an SPI (i.e., Serial Peripheral Interconnect) bus, or a proprietary bus.

Printer 10 may include one or more input ports 52 coupled to e.g., I/O controller 22 of system board 14. Input port 52 may be e.g., a parallel printer port, a USB (i.e., universal serial bus) port and/or a network interface port (i.e., for allowing printing device 10 to function as a network device within a computer network). Printer 10 may receive print jobs 54 via input port 52. As discussed above, print jobs 54 may be single-page or multi-page print jobs, and multi-page print jobs may include data that is common across multiple pages. Additionally, a multi-page print job may include e.g., the printing of one ten-page document or e.g., the printing of ten one-page documents.

Printing device 10 may execute a printer optimization system 56 that processes received print jobs (e.g., print job 54) to determine if common images exist between the various pages of multi-page print jobs.

The instruction sets and subroutines of printer optimization system 56, which are typically stored on a storage device (e.g., ROM 20), may be executed by one or more processors (e.g., processor 16) and one or more memory architectures (e.g., RAM 18) incorporated into printing device 10. While the storage device is shown to be ROM 20, other configurations are possible. For example, the storage device may be, for example, a hard disk drive, a tape drive, an optical drive, a RAID array, and/or random access memory (RAM).

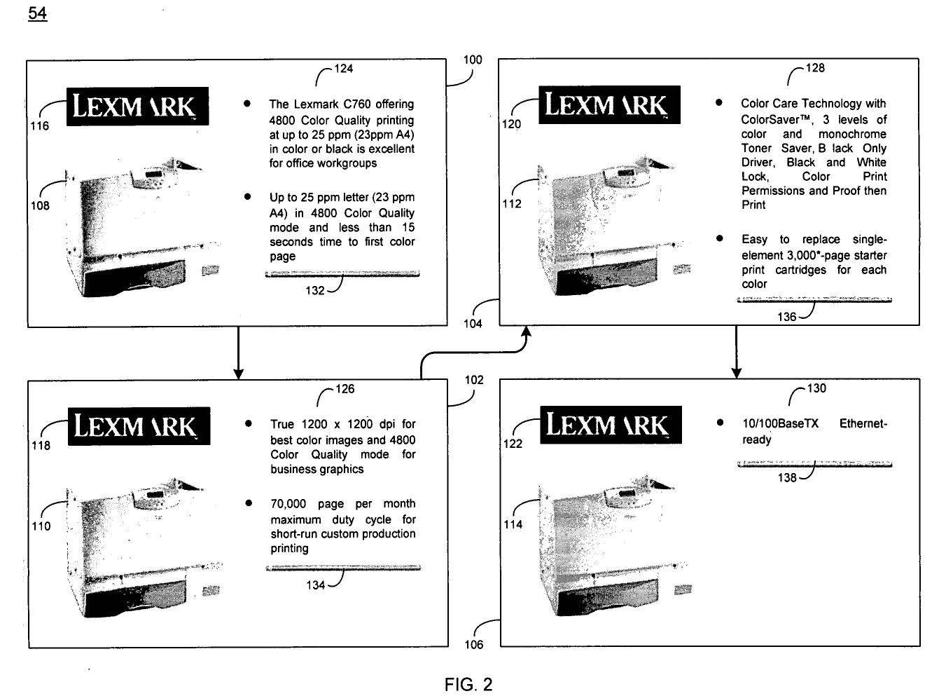

Referring also to FIG. 2, print job 54 is shown to be a presentation that includes four slides 100, 102, 104, 106, in which each slide includes both image objects and text objects. Other object types may also be included within print job 54, such as fill objects (not shown). In this exemplary presentation, each of the four slides 100, 102, 104, 106 includes an identical image of a printer 108, 110, 112, 114 (respectively) and an identical image of a corporate logo 116, 118, 120, 122 (respectively). Accordingly, concerning exemplary presentation 54, each slide is identical except for the bulleted text 124, 126, 128, 130 (respectively) included within each slide.

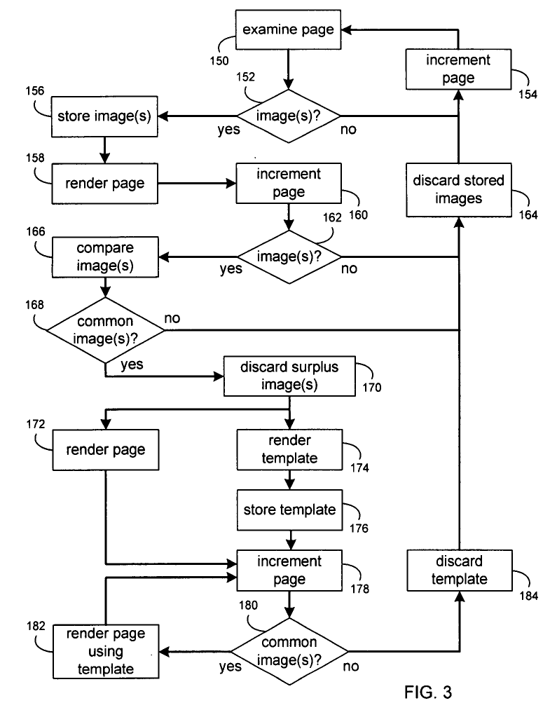

Referring also to FIG. 3, upon printing device 10 receiving a print job (e.g., print job 54), printer optimization system 56 may examine 150 the objects associated with each page of the print job to determine 152 if redundant image objects exist across multiple pages of the print job.

For example, when print job 54 is received by printing device 10, printer optimization system 56 may examine 150 the first page 100 of print job 54 to determine 152 if the page being examined includes any image objects. In the event that the page being examined (e.g., page 100) fails to include any image objects, printer optimization system 56 may increment 154 the page count (e.g., from first page 100 to second page 102) and examine 150 second page 102 to determine if second page 102 includes any image objects.

However, in exemplary print job 54, first page 100 includes two image objects, namely image object 108 (e.g., an image of a printer) and image object 116 (e.g., an image of a corporate logo). Additionally, first page 100 includes one text object 124 that includes bulleted text.

Accordingly, when receiving the first page 100 of print job 54, three objects are received by printing device 10, namely image objects 108, 116 and text object 124. Additionally, various other commands/instructions may be included that define e.g., media size, media type, print job resolution, and print job density, for example. Upon determining 152 that print job 54 includes image objects (e.g., image objects 108, 116), printer optimization system 56 stores 156 image objects 108, 116 within e.g., RAM 18 (FIG. 1). Printing device 10 may then render 158 page 100. Rendering is the process of converting the objects received by printing device 10 into the various PELs (i.e., pixel elements) that comprise the printed image produced by printing device 10. For example, printing device 10 renders 158 image objects 108, 116 and text object 124 to produce a sheet of printed media representative of page 100 of print job 54.

Printer optimization system 56 may increment 160 the page being processed so that e.g., page 102 of print job 54 is processed by printer optimization system 56. When processing page 102 of print job 54, printer optimization system 56 may determine 162 if page 102 of print job 54 includes any image objects. In the event that page 102 failed to include any image objects, printer optimization system 56 may discard 164 the previously-stored 156 image objects and increment 154 the page count (e.g., from second page 102 to third page 104) and examine 150 third page 104 to determine 152 if third page 104 includes any image objects.

However and as discussed above, second page 102 includes two image objects, namely image object 110 (which is an image of a printer) and image object 118 (which is an image of a corporate logo). Printer optimization system 56 may compare 166 the previously-stored 156 image objects from page 100 to the images objects included within page 102 of print job 54 to determine 168 if there are common objects. As discussed above and in this exemplary print job 54, image object 110 (of page 102) is identical to image object 108 (of page 100), and image object 118 (of page 102) is identical to image object 116 (of page 100). When comparing 166 image objects to determine 168 if a set of common objects exists, various characteristics of the image objects may be compared, such as: image geometry (i.e., which defines the location of the image object); image scaling (i.e., which defines a scaling factor for the image object); and image content (i.e., which defines the content of the image object).

In the event that printer optimization system 56 determines 168 that no common objects exist, printer optimization system 56 may discard 164 the previously-stored 156 image objects and increment 154 the page count (e.g., from second page 102 to third page 104) and examine 150 third page 104 to determine 152 if third page 104 includes any image objects.

Typically, when image objects are received by printing device 10, they are received in a compact format that allows for more efficient transfer from the computer (not shown) that is providing the print job. For example, an image object that is going to have a final rendered size of 300×300 pixels may be transferred to printing device 10 as a 100×100 pixel image object, with an image scaling factor of three. Accordingly, when rendering the image object, printing device 10 may enlarge the 100×100 pixel image object by a factor of three into a 300×300 image object. Additionally, when an image object is received for a particular page of a particular print job, an image geometry factor may properly locate the image object on the printed page. For example, for the above-described 300×300 pixel image object, an image geometry factor may locate the upper left-hand corner of the 300×300 pixel image object at 100 pixels to the right of the left-hand side of the printed page, and 100 pixels down from the top of the printed page.

Accordingly, when comparing 166 image objects to determine 168 a set of common objects, printer optimization system 56 may require that the object compared have e.g., identical image geometry, identical image scaling, and identical image content. As discussed above, image object 110 (of page 102) is identical to image object 108 (of page 100), and image object 118 (of page 102) is identical to image object 116 (of page 100). Accordingly, the two previously-stored images 108, 116 are common objects (i.e., objects that are common between page 100 and page 102 of print job 54).

Assume for illustrative purposes that pages 100, 102, 104, 106 each include an additional image object, namely image objects 132, 134, 136, 138 (respectively). However, unlike the previously discussed image objects, images objects 132, 134, 136, 138 are not identical, as they are located at different locations within each page of the print job. Accordingly, while image object 132 may be stored 156 by printer optimization system 56 when processing page 100, when comparing image object 132 (from page 100) to image object 134 (i.e., from page 102), as image objects 132, 134 are not identical (i.e., having different image geometry factors), image object 132 may be determined 168 by printer optimization system 56 to not be a common object.

In the event that an image object previously-stored 156 by printer optimization system 56 is determined 168 to not be a common object, printer optimization system 56 may discard 170 the surplus image objects (i.e., image objects that were previously-stored 156 from page 100 but not included within page 102). Accordingly, as image object 132 is not determined 168 to be a common object, printer optimization system 56 may discard 170 image object 132.

Printing device 10 may render 172 second page 102. Additionally, printer optimization system 56 may render 174 and store 176 a template page for use when render subsequent pages.

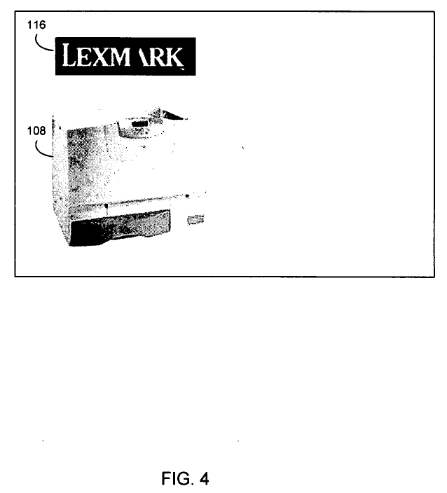

For example and referring also to FIG. 4, printer optimization system 56 may render 174 and store 176 template page 200 that includes the previously-determined 168 common image objects, namely image objects 108, 116. Template page 200 may be stored 176 within e.g., RAM 18 (FIG. 1). When rendering 174 template page 200, printer optimization system 56 may render template page 200 outright using the common image objects 108, 116. Alternatively, when page 102 is being rendered 172 by printing device 10, a partially-rendered version of page 102 may be saved by printer optimization system 56 as template page 200. For example, assume that when rendering 172 page 102, printing device 10 first defines the printing area (e.g., as an 8 1/2″×11″ landscape page) and defines the position of image objects 110, 118 (which, as discussed above, are identical to image objects 108, 116 of page 100). Accordingly, once page 102 is partially-rendered to include image objects 110, 118, the partially-rendered page may be saved as template page 200. Once template page 200 is saved, printing device 10 may then complete the rendering 172 of page 102.

Once template page 200 is rendered 174 and stored 176, printer optimization system 56 may increment 178 the page being processed so that e.g., third page 104 of print job 54 is processed by printer optimization system 56. Printer optimization system 56 may process third page 104 to determine 180 if page 104 includes any previously-determined 168 common image objects. As discussed above, image objects 108, 116 (from page 100) were determined 168 to be common image object, as they are identical to image objects 110, 118 (respectively) that appear in page 102. Further and as discussed above, image object 112 (of page 104) is identical to common image object 108 (from page 100), and image object 120 (from page 104) is identical to common image object 116 (from page 100). Accordingly, as page 104 includes common image objects, printer optimization system 56 may render 182 page 104 using template page 200 as a starting point. For example, page 104 include four objects, namely image objects 112, 120, 136 and text object 128. Of these four objects, two of the objects (i.e., image objects 112, 120) are identical (i.e., in content, position and scale) to objects within page 100 (i.e., common objects 108, 116). Accordingly, when rendering 182 page 104, by using template page 200 as a starting point, the only additional objects that need to be rendered are the objects unique to page 104, namely image object 136 and text object 128.

When rendering 182 page 104 using template page 200, a copy of template 200 is retrieved from e.g., RAM 18, modified to include objects 128, 136, and rendered 182 as page 104. Further, template page 200 (in its unmodified state) continues to be maintained within e.g., RAM 18 for use as a starting point for future rendered pages.

In the event that page 104 failed to include any common image objects, printer optimization system 56 may: discard 184 the previously-stored 176 template page 200; discard 164 the previously-stored 156 image objects (i.e., common objects 108, 116); increment 154 the page count (e.g., from third page 104 to fourth page 106); and examine 150 fourth page 106 to determine if fourth page 106 includes any image objects.

However and as discussed above, as page 104 includes common image objects, printer optimization system 56 may render 182 page 104 using template page 200 as a starting point. Once third page 104 is rendered 182 using template page 200, printer optimization system 56 may increment 178 the page being processed so that e.g., fourth page 106 of print job 54 is processed by printer optimization system 56.

Printer optimization system 56 may process fourth page 106 to determine 180 if page 106 includes any previously-determined 168 common image objects. As discussed above, image objects 108, 116 (from page 100) were determined 168 to be common image object, as they are identical to image objects 110, 118 (respectively) that appear in page 102. Further and as discussed above, image object 114 (of page 106) is identical to common image object 108 (from page 100), and image object 122 (from page 106) is identical to common image object 116 (from page 100).

As page 106 includes common image objects (i.e., image object 114 is identical to common image object 108 and image object 122 is identical to common image object 116), printer optimization system 56 may render 182 page 106 using template page 200 as a starting point. Accordingly, when rendering 182 page 106 using template page 200 as a starting point, the only additional objects that need to be rendered are the objects unique to page 106, namely image object 138 and text object 130.

When processing the last page of a print job, printer optimization system 56 will not be able to increment 154, 160, 178 the page count to process the next page in the print job. Accordingly, in the event that printer optimization system 56 fails to increment the page count, the end of the print job has been reached and printer optimization system 56 may be reset.

While printer optimization system 56 is described above as determining 152, 162 if the page being processed includes any image objects (regardless of the sequence in which the objects are received), other configurations are possible. For example, printer optimization system 56 may be configured to only determine that an image object is included within a page if the first object received for the page is an image object. Accordingly, in the event that the first object received for a page is e.g., a text object, determinations 152, 162 would fail, regardless of whether subsequent objects included within the page are image objects.

Typically, when examining 150 objects received within a page of a print job, only the first set of objects included within the page are examined. However, other configurations are available. For example, subsequent sets of image objects may be examined 150. When examining subsequent sets of image objects, extra information in the form of e.g., a mask must be kept, which describes which pixels were rendered to template page 200, such that when template page 200 is used to render subsequent pages, only the pixels that were previously rendered in template page 200 are changed in the subsequently rendered pages.

While printer optimization system 56 is described above as determining 168 the existence of common image objects irrespective of the sequence in which the image objects are received, other configurations are possible. For example, printer optimization system 56 may be configured to only determine that common image objects exist if the image objects received in a subsequent page are received in the same order as the image objects received in the previous page. Accordingly, in the event that a previous page included image objects A, B, C and a subsequent page included the identical objects arranged in a different sequence (e.g., C, B, A), determination 168 would fail.

A number of implementations have been described. Nevertheless, it will be understood that various modifications may be made. Accordingly, other implementations are within the scope of the following claims.

What is claimed is:

1. A method comprising:
if an initial page of a multi-page print job includes one or more image objects, storing the one or more image objects of the initial page;
if a first subsequent page of the multi-page print job includes one or more image objects, comparing the one or more image objects of the initial page to the one or more image objects of the first subsequent page to determine one or more common image objects;
rendering a template page that includes the one or more common image objects; and
if a second subsequent page of the multi-page print job includes one or more image objects that correspond to the one or more common image objects, rendering the second subsequent page using the template page.

2. The method of claim 1 further comprising:
rendering the initial page of the multi-page print job; and
rendering the first subsequent page of the multi-page print job.

3. The method of claim 1 wherein comparing the one or more image objects of the initial page to the one or more image objects of the first subsequent page includes:
comparing the image characteristics of the one or more image objects of the initial page to the image characteristics of the one or more image objects of the first subsequent page.

4. The method of claim 3 wherein the image characteristics include image geometry.

5. The method of claim 3 wherein the image characteristics include image scaling.

6. The method of claim 3 wherein the image characteristics include image content.

7. The method of claim 1 further comprising:
if the first subsequent page of the multi-page print job does not include one or more image objects, discarding the one or more image objects of the initial page.

8. The method of claim 1 further comprising:
discarding at least one image object included within the one or more image objects of the initial page that is not included within the one or more common image objects.

9. The method of claim 1 further comprising:
if the second subsequent page of the multi-page print job does not include one or more image objects that correspond to the one or more common image objects, discarding the one or more common image objects.

10. The method of claim 1 further comprising:
storing the template page.

11. The method of claim 10 further comprising:
if a second subsequent page of the multi-page print job does not include one or more image objects that correspond to the one or more common image objects, discarding the template page.

12. A computer program product residing on a computer readable medium having a plurality of instructions stored thereon which, when executed by a processor, cause the processor to:
if an initial page of a multi-page print job includes one or more image objects, store the one or more image objects of the initial page;
if a first subsequent page of the multi-page print job includes one or more image objects, compare the one or more image objects of the initial page to the one or more image objects of the first subsequent page to determine one or more common image objects;
render a template page that includes the one or more common image objects; and
if a second subsequent page of the multi-page print job includes one or more image objects that correspond to the one or more common image objects, rendering the second subsequent page using the template page.

13. The computer program product of claim 12 further comprising instructions for:
rendering the initial page of the multi-page print job; and
rendering the first subsequent page of the multi-page print job.

14. The computer program product of claim 12 wherein the instructions for comparing the one or more image objects of the initial page to the one or more image objects of the first subsequent page include instructions for:
comparing the image characteristics of the one or more image objects of the initial page to the image characteristics of the one or more image objects of the first subsequent page.

15. The computer program product of claim 14 wherein the image characteristics include image geometry.

16. The computer program product of claim 14 wherein the image characteristics include image scaling.

17. The computer program product of claim 14 wherein the image characteristics include image content.

18. The computer program product of claim 12 further comprising instructions for:
if the first subsequent page of the multi-page print job does not include one or more image objects, discarding the one or more image objects of the initial page.

19. The computer program product of claim 12 further comprising instructions for:
discarding at least one image object included within the one or more image objects of the initial page that is not included within the one or more common image objects.

20. The computer program product of claim 12 further comprising instructions for:
if the second subsequent page of the multi-page print job does not include one or more image objects that correspond to the one or more common image objects, discarding the one or more common image objects.

21. The computer program product of claim 12 further comprising instructions for:
storing the template page.

22. The computer program product of claim 21 further comprising instructions for:
if a second subsequent page of the multi-page print job does not include one or more image objects that correspond to the one or more common image objects, discarding the template page.

23. A printing device including an integrated circuit configured for:
if an initial page of a multi-page print job includes one or more image objects, storing the one or more image objects of the initial page;
if a first subsequent page of the multi-page print job includes one or more image objects, comparing the one or more image objects of the initial page to the one or more image objects of the first subsequent page to determine one or more common image objects;
rendering a template page that includes the one or more common image objects; and
if a second subsequent page of the multi-page print job includes one or more image objects that correspond to the one or more common image objects, rendering the second subsequent page using the template page.

24. The printing device of claim 23 wherein the integrated circuit is further configured for:
rendering the initial page of the multi-page print job; and
rendering the first subsequent page of the multi-page print job.

25. The printing device of claim 23 wherein comparing the one or more image objects of the initial page to the one or more image objects of the first subsequent page includes:
comparing the image characteristics of the one or more image objects of the initial page to the image characteristics of the one or more image objects of the first subsequent page.

26. The printing device of claim 25 wherein the image characteristics include image geometry.

27. The printing device of claim 25 wherein the image characteristics include image scaling.

28. The printing device of claim 25 wherein the image characteristics include image content.

29. The printing device of claim 23 wherein the integrated circuit is further configured for:
if the first subsequent page of the multi-page print job does not include one or more image objects, discarding the one or more image objects of the initial page.

30. The printing device of claim 23 wherein the integrated circuit is further configured for:
discarding at least one image object included within the one or more image objects of the initial page that is not included within the one or more common image objects.

31. The printing device of claim 23 wherein the integrated circuit is further configured for:
if the second subsequent page of the multi-page print job does not include one or more image objects that correspond to the one or more common image objects, discarding the one or more common image objects.

32. The printing device of claim 23 wherein the integrated circuit is further configured for:
storing the template page.

33. The printing device of claim 32 wherein the integrated circuit is further configured for:
if a second subsequent page of the multi-page print job does not include one or more image objects that correspond to the one or more common image objects, discarding the template page.
